(19) United States
(12) Patent Application Publication
(10) Pub. No.: US 2005/0217332 A1
(43) Pub. Date: Oct. 6, 2005

(54) Environmentally friendly poultry litter fertilizer

(76) Inventors: William W. Keller, Batesville, AR (US); Lyn Kelley, Sulphur Rock, AR (US)

Correspondence Address: BLANK ROME LLP, 600 NEW HAMPSHIRE AVENUE, N.W., WASHINGTON, DC, 20037, US

(21) Appl. No.: 10/816,850

(22) Filed: Apr. 5, 2004

(51) Int. Cl. C05F 1/00

(52) U.S. Cl. 71/11

(57) ABSTRACT

The present invention relates to a poultry litter-based fertilizer composition and method of making thereof. In particular, the fertilizer of the present invention has acceptable odor and retains valuable nitrogen, while keeping phosphorus levels under control. The fertilizer of the present invention comprises poultry litter, calcium carbonate, and a binding agent.

### FIELD OF THE INVENTION

The present invention relates generally to a poultry litter-based fertilizer composition and method of making this composition. In particular, the fertilizer of the present invention is without odor and retains valuable nitrogen, while keeping phosphorus levels under control.

### BACKGROUND OF THE INVENTION

Poultry manure has long been used as a material to enhance soil productivity. Poultry manure contains organic protein, inorganic nitrogen, fiber and minerals. For reasons related to animal husbandry, the manure is frequently available as poultry litter which is a mixture with straw and/or other bedding materials, and suitable for use as a soil conditioner.

Prior use of poultry litter as a fertilizer material has been somewhat restricted by low nitrogen content and the often accompanying malodor. Preparation of the raw manure invariably leads to unwanted decomposition and loss of nitrogen. Malodor is not surprising and something of a byproduct of the decomposition process. Another drawback to the use of raw poultry litter includes the adverse environmental effect of phosphate, including water contamination and eutrophication.

An animal feed supplement is disclosed in U.S. Pat. No. 3,939,280. While not directed to a fertilizer composition, it references use of poultry manure as a soil enriching agent and an incumbent nitrogen content of 3% to 4%. Typically, however, fertilizer compositions of the type described herein have nitrogen contents on the order of about 2%.

U.S. Pat. No. 3,718,451 discloses a fertilizer/soil conditioner prepared from chicken manure which is formulated by combining it with a urea-formaldehyde foam resin. While the material is described as imparting a 15% assimilable nitrogen content, it does so only by use of a resin which has since fallen into environmental disfavor because of the formaldehyde component. Likewise, U.S. Pat. No. 4,193,786 discloses the high nutrient value available from a composting mixture of animal manure and sawdust. Such a filler material is necessary to achieve the desired structural characteristics and remedy the degradation of nitrogen content during composting.

U.S. Pat. No. 4,292,328 discloses a thermophilic aerobic digestion process for producing proteinaceous materials suitable for animal feed, from the manure of those animals including poultry. Continuous use of an oxygenating gas and maintenance of mesophilic microbiological temperatures serves to digest the raw material to the extent desired. Digestion, however, involves the degradation of organic materials and, invariably, the loss of nitrogen content. Fortuitously, the method described includes the utilization of atmospheric nitrogen to account for digestive losses.

U.S. Pat. No. 4,909,825 discloses a method which uses pre-formed particulate carders of thermoenergy and microorganisms for the processing of raw manure. The process parameters disclosed necessitate a decomposition with inherent loss of nutrient value. In U.S. Pat. No. 4,218,233 such a concern is addressed, along with the odor problem which often accompanies any poultry process. This reference describes the use of biologically-active cow manure as a source of aerobic thermophilic bacteria to inoculate poultry excrement to control odor and prevent nitrogen loss through lower ammonia production.

U.S. Pat. No. 5,730,772 discloses a method for preparing fertilizer having slow-release nitrogen component without the use of polymeric binders. This method involves aerating, drying and cultivating at an elevated temperature to sterilize the manure. Although this composition retains a high nitrogen level, it does not directly address the high phosphorus concentration problem, which is a major environmental concern associated with poultry litter fertilizer. High phosphate concentration in soil treatment compositions can cause severe environmental pollution, such as contamination of soil and ground water, and eutrophication of surface water.

Therefore, there remains a need for poultry litter fertilizer that has acceptable odor and retains valuable nitrogen, while keeping a lower phosphorus level. The present invention takes raw poultry, which has high levels of phosphorus and noxious odor, and transforms it into a mild, environmentally friendly fertilizer, while retaining valuable nitrogen content.

### SUMMARY OF THE INVENTION

The fertilizer of the present invention comprises poultry litter, calcium carbonate, and a binding agent. Preferably, the fertilizer contains about 20-70% by weight of poultry litter, about 20-70% by weight of calcium carbonate, and about 2-8% by weight of the binding agent. The calcium carbonate is effective for removing odor as well as reducing phosphate levels.

A method for producing the fertilizer is also provided.

### BRIEF DESCRIPTION OF THE DRAWINGS

FIG. 1 is a schematic drawing of a preferred process for making the present fertilizer.

### DETAILED DESCRIPTION OF THE PREFERRED EMBODIMENT

The fertilizer of the present invention comprises poultry litter, calcium carbonate, and a binder. The relative amounts of the components are preferably about 20-70% by weight of poultry litter, most preferably about 55-65%; about 20-70% by weight of calcium carbonate, most preferably about 35-45%; and about 2-8% by weight of the binding agent, most preferably about 3%.

The calcium carbonate eliminates malodor and reduces phosphorus content. In an embodiment, the calcium carbonate can be added in the form of dolomitic limestone. Dolomitic limestone is a commercially available agricultural product containing both calcium carbonate (about 54%) and magnesium carbonate (about 36%).

The binder is used to bind the fertilizer together to form pellets or granules. The preferred binder is calcium lignosulfonate in an aqueous solution of about 35-65%. Although calcium lignosulfonate is preferred, other binders, such as sodium lignosulfonate and molasses, are also appropriate for the present invention.

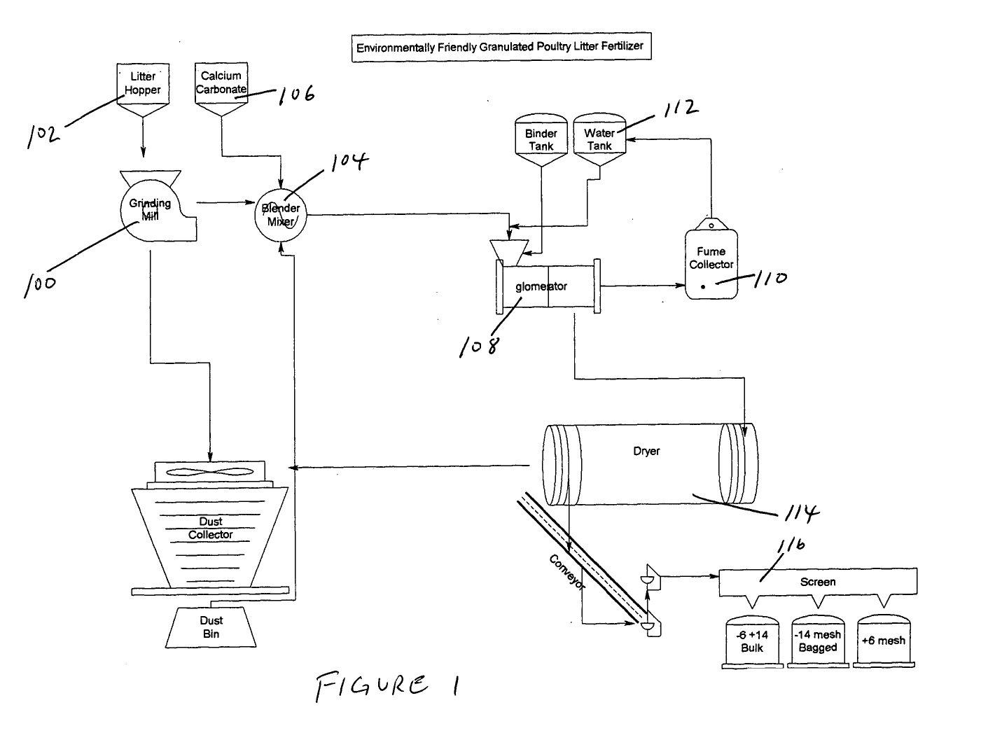

The invention is made by mixing poultry litter, calcium carbonate, and the binder together to form a homogeneous mixture. FIG. 1 illustrates a preferred process for making the present fertilizer. The raw poultry litter is first grounded to a consistent particle size of less than about 30-mesh in a grinding mill 100. The raw litter is metered into the grinding mill 100 from a litter hopper 102 that stores the raw poultry litter. The litter hopper 102 preferably contains a weighing mechanism to properly dispense controlled amounts of poultry litter into the grinding mill 100.

The ground-litter is then mixed with the calcium carbonate in a blender/mixer 104. Preferably 3 parts of poultry litter is mixed with 2 parts of calcium carbonate. Although a ratio of 3:2 is preferred, the process can accommodate litter to calcium carbonate ratios of about 2:7 to about 7:2. The calcium carbonate is preferably stored in a calcium carbonate hopper 106 that dispenses calcium carbonate directly into the blender/mixer 104. Like the litter hopper 102, the calcium carbonate hopper 106 preferably contains a weighing mechanism to dispense proper amounts of calcium carbonate into the blender/mixer 104 which blends the ground-litter and calcium carbonate into a blended, homogeneous mixture. Binder is then added to and mixed with the homogeneous mixture inside the blender/mixer 104 by spraying with the binding agent on to the mixture during the blending process. The binder is preferably an aqueous solution of about 35-65%, most preferably about 50%.

After spraying and mixing, the materials are transported, preferably via conveyors, to an agglomerator 108 for processing into pellet or granulated fertilizer. The agglomerator 108 subjects the mixture to a rolling process while at the same time continually spraying the mixture with additional binder. Preferably, the agglomerator 108 contains at least one sprayer mounted thereon to facilitate the spraying process during the rolling operation. Typically, the spaying is adequate to bind the mixture forming pellets or granules. The final product preferably has about 2-8% by weight of the binder, most preferably about 3%. In a preferably embodiment, the agglomerator 108 is vented to a fume collector 110 to collect venting ammonia. The ammonia is preferably collected as an aqueous solution that is stored in a water tank 112 for subsequent recycling by spraying the ammonia on to the mixture in the agglomerator 108. Because the ammonia contains valuable nitrogen, its recycling adds valuable nitrogen to the fertilizer that, otherwise, would have been lost in processing.

The agglomerator 108 produces wet pellets or granules that can further be dried in a dryer system 114, preferably a drum dryer. The dryer preferably contains heat controls that set limits required to properly dry the fertilizer. Preferably, the wet pellets or granules is dried by heated air. The air preferably enters the dryer at about 300-500° F., most preferably 350° F., and exits at about 95-110° F. The pellets or granules preferably remain in the dryer for about 15-20 minutes to completely remove the moisture. The dried product should be a hard, dry pellet or granule which is then transported, preferably by a conveyor system, to a screening system 116 that separates the dried pellets or granules by size. Typically, the screening system 116 separates the pellets or granules into two different sizes: −6 to 20 mesh and greater than 20 mesh. The smaller pellets or granules are used fur bulk application, such as field application, while the larger pellets or granules are used for bagged application, such as for lawn and garden.

Throughout the process all discharging points in the processing system is vented and collected for recycling. For example, dust from the grinding mill 100 and dryer system 114 is collected and eventually recycled to the blender/mixer 104. The complete process is preferably enclosed in a self-contained structure to eliminate the release of dust and odor to the environment.

The following Table 1 compares the fertilizer of the present invention (I) with raw poultry litter (II)

TABLE 1

| | II | I |
|---|---|---|
| Total Nitrogen | 2.63% | 1.00-2.50% |
| Total Phosphorus | 1.42% | 0.35% |
| Total Potassium | 3.67% | 0.97% |
| Total Calcium | 2.80% | 20.65% |
| Carbonates | 0% | 17.81% |
| Total Valued Pounds Per Ton | 178.5 | 809.0 |
| Wasted Pounds Per Ton | 1821.5 | 1191.0 |
| Estimated Pounds Used Per Acre | 4000 | 500 |

The invention has been disclosed broadly and illustrated in reference to representative embodiments described above. Those skilled in the art will recognize that various modifications can be made to the present invention without departing from the spirit and scope thereof.

1. A fertilizer comprising poultry litter, calcium carbonate, and a binding agent.

2. The fertilizer of claim 1, wherein the fertilizer is in the form of pellets or granules.

3. The fertilizer of claim 1, wherein the binding agent is calcium lignosulfonate.

4. The fertilizer of claim 1, wherein the total nitrogen content is about 1-2.5% and the phophorus content is about 0.35%.

5. The fertilizer of claim 1, wherein the calcium carbonate is present in an amount of about 20-70%.

6. The fertilizer of claim 1, wherein the binder is present in an amount of about 2-8%.

7. The fertilizer of claim 1, wherein the poultry litter is present in an amount of about 20-70%.

8. The fertilizer of claim 1, wherein the calcium carbonate is dolomitic limestone.

9. A method for making fertilizer comprising the step of mixing poultry litter, calcium carbonate, and a binder.

10. The method of claim 9, further comprising the step of drying the fertilizer.

11. The method of claim 9, wherein the poultry litter is grounded before mixing.

12. The method of claim 9, wherein the fertilizer is in the form of pellets or granules.

13. The method of claim 12, further comprising the step of screening the fertilizer to separate the pellet size.

14. The method of claim 9, wherein the binding agent is calcium lignosulfonate.

15. The method of claim 5, wherein the total nitrogen content is about 1-2.5% and the phophorus content is about 0.35%.

16. The method of claim 9, wherein the calcium carbonate is present in an amount of about 20-70%.

17. The method of claim 9, wherein the binder is present in an amount of about 2-8%.

18. The method of claim 9, wherein the poultry litter is present in an amount of about 20-70%.

19. The method of claim 9, wherein the calcium carbonate is dolomitic limestone.
